(19) United States
(12) Patent Application Publication
(10) Pub. No.: US 2004/0135968 A1
(43) Pub. Date: Jul. 15, 2004

(54) Contact lens having an optimized optical zone

(76) Inventors: Courtney Flem Morgan, Alpharetta, GA (US); Joseph Michael Lindacher, Lawrenceville, GA (US)

Correspondence Address: NOVARTIS, CORPORATE INTELLECTUAL PROPERTY, ONE HEALTH PLAZA 430/2, EAST HANOVER, NJ, 07936-1080, US

(21) Appl. No.: 10/725,282

(22) Filed: Dec. 1, 2003

Related U.S. Application Data
(60) Provisional application No. 60/431,956, filed on Dec. 9, 2002.

(51) Int. Cl. G02C 7/04; G02C 7/10

(52) U.S. Cl. 351/164

(57) ABSTRACT

A contact lens having one or more optimized optical zones that accommodate the specific optical variations of the eye of the wearer such that the optical zone s is placed within the contact lens in relation to the true line of sight of the wearer. To make the contact lens, the variation in the eye of a potential contact lens wearer is measured to determine the true line of sight of the eye, and the location of one or more optical zones in the contact lens are determined such that the optical zone is placed substantially on the true line of sight when fitted in the eye of the wearer, and then the contact lens is manufactured to contain the one or more optimized optical zones.

This application claims under 35 USC § 119(e) the benefit of the filing date of U.S. Provisional No. 60/431,956 filed Dec. 09, 2002 and all references incorporated therein.

### BACKGROUND OF THE INVENTION

1. Field of the Invention

The present invention generally relates to ophthalmic lenses. More particularly, the invention relates to a contact lens that includes an optimized optical zone specifically positioned within the contact lens to accommodate true line of sight of the eye of the subject.

2. Description of the Related Art

Contact lenses are ophthalmic lenses worn on the anterior cornea that are widely used for correcting many different types of vision deficiencies. These include defects such as near-sightedness (myopia) and far-sightedness (hypermetropia), astigmatism, and defects in near range vision usually associated with aging (presbyopia). A typical single vision contact lens has a “focus,” which is the point at which parallel rays of light focus when the lens is placed perpendicular to the parallel rays, and an optical axis, which is an imaginary line drawn from the focus to the center of the lens. A posterior surface of the contact lens fits against the cornea and an opposite anterior surface has an optical zone that focuses light to correct vision. In the case of a typical spherical lens, the optical zone has a single radius of curvature that is the distance from any point on the optical zone to a point on the optical axis referred to as the center of curvature.

A bifocal lens has at least two optical zones, typically on the anterior surface, of the lens: a distance optical zone, for gazing at far off objects; and a near optical zone, for gazing at close objects (e.g., while reading). One type of bifocal contact lens is concentric or segmented in configuration. In a conventional, simultaneous vision, concentric bifocal contact lens, a first, centrally located, circular correction zone constitutes either distant or near vision correction, while a second annular correction zone surrounding the first zone provides the corresponding near or distance vision correction, respectively. In a conventional, alternating vision, bifocal contact lens of the segmented or translating type, the lens is divided into two optical zones. Usually, the upper zone is for distance vision correction whereas the lower zone is for near vision correction. With such a translating lens, the distance portion (upper zone) of the lens is in front of the pupil of the eye in primary gaze, while in downward gaze, the add power or near portion (lower zone) of the lens is aligned to the pupil. Effective use of a bifocal contact lens requires translation of the eye between optical zones when the eye changes from primary gaze to downgaze. In such a situation, the pupil must move from being subtended by the distance optical zone to being subtended by the near optical zone.

The optical zone, is the portion of the contact lens that, provides the correct refractive correction for the subject's eye. The location of the optical zone over the eye is important for the efficient function of the optical system defined by the lens and the eye. And the optimal location of the optical zone is determined by the optical design and the line of sight of the eye. However, prior art contact lenses typically assume that the line of sight of the eye lies along the geometric or mechanical center of the eye.

In prior art lenses, such as the prior art bifocal lens 10 shown in FIG. 1, the location of the optical zones 12 and 14 are placed relative to the geometric line of sight 5 of the contact lens 10. Thus, the primary optical zone 10 surrounds the geometric line of sight 5 and assumes that the light will enter the eye therethrough and accordingly will effect the appropriate amount of focusing and orientation of the passing light. A second optical zone 14 is beneath the first optical zone 12 and used for near objects. The contact lens 10 will typically include a mechanical means known in the art, such as a raised portion on the surface of the lens, that causes the contact lens 10 to correctly align such that the lower optical zone 14 is over the pupil when the wearer gazes downward and assumedly requires the focal change.

Due to the decentration of the fovea, (typically temporal and inferior), and the eye's aberrations, the line of sight of the eye is not typically aligned to the geometric or mechanical axis of the eye. In such case, the contact lens will not provide optimal visual adjustment to the images conveyed to the eye of the wearer. Furthermore, the difference in the optical zone deviation from the geometric assumption of the line of sight can be more dramatic in a series of optical zones where the secondary optical zone(s) are significantly distant from the assumed visual and geometric axis of the eye. Accordingly, it would be advantageous to provide a contact lens and method of manufacture that can better align the one or more optical zones of the contact lens with the true line of sight of the eye of the wearer. Such a contact lens should be able to utilize specific measurements unique to the individual eye of the wearer to determine with precision the location of the true line of sight and optimal location for the optical zone(s). It is therefore to such an improved contact lens that the present invention is directed.

### SUMMARY OF THE INVENTION

The present invention is a contact lens having one or more optimized optical zones that accommodate the specific optical variations of the eye of the wearer whereby the optical zone(s) are placed within the contact lens in relation to the true line of sight of the wearer. To determine the true line of sight of the eye, the variation in the eye of a potential contact lens wearer is measured and the location of the one or more optimal optical zones in the contact lens can be determined such that the optical zone is placed substantially on the true line of sight. The contact lens can include mechanical features such that the one or more optical zones are positionally maintained in the eye while worn by the wearer, such as ridges, slabs-offs, ballast, and other methods known in the art.

The invention also includes a method for manufacturing a contact lens having one or more optimized optical zones that can accommodate the specific optical variations of the eye of the wearer, having the steps of obtaining information about the true line of sight of the eye, wherein the true line of sight of the eye is determined by measuring the variation in the eye of a potential contact lens wearer, determining one or more optimal optical zones for a contact lens used in the eye of the potential wearer such that the optical zone is placed substantially on the true line of sight, and then manufacturing the contact lens to contain the one or more optimal optical zones. Methods such as eye and lens tracking can be used to clinically determine the location of the contact lens relative to the geometrical center of the eye. Wavefront analysis in conjunction with corneal topography can clinically determine the true line of sight of the eye relative to the geometrical center of the eye, and be utilized to determine where the optical zone(s) should be placed in the contact lens to establish the desired optical system for the wearer.

In one embodiment, the manufacture of the contact lens can occur through a multi-axis cutting system, such as a three axis lathe, and as is further described herein. In addition, the clinical measurements and in situ experience of the wearer can be used in an iterative fashion to optimize the mechanical features of a lens such that the placement of the optical zone(s) is optimized simultaneously to the line of sight and any other anatomical, optical, or other optic feature desired.

In sum, the present invention can alter the location of the optical zone(s) on the contact lens carrier such that the zone(s) can be optimized relative to the true line of sight either by decentering the optical zone(s) on the lens based upon the results of the lens movement equilibrium and steady-state positions, or through adjusting the mechanical features of the lens to permit centered optics to be carried in the optimum location by the contact lens. The present invention accordingly provides an advantage in that the inventive contact lens and method of manufacture can utilize the unique measurements of the individual eye of the wearer to align the one or more optical zones of the contact lens with the true line of sight of the eye of the wearer, and not assume simple alignment of the line of sight with the geometric or mechanical access. The precision of location of optical zone(s) thus gives a wearer having a non-geometrically centered line of sight a modification of vision superior to that of a prior art geometric line of sight contact lens.

Other objects, advantages, and features of the present invention will become apparent after review of the hereinafter set forth Brief Description of the Drawings, Detailed Description of the Invention, and the Claims.

### BRIEF DESCRIPTION OF THE DRAWINGS

FIG. 1 is a front view of a prior art bifocal contact lens having a first optical zone centered about the geometric center axis of the lens, and a second optical zone directly beneath the first optical zone.

FIG. 2 is a front view of the present inventive contact lens manufactured as bifocal and having optimized optical zones that are adjusted to be in the true line of sight for the specific eye of the wearer.

FIG. 3A is a top view of a cross-section of an eye having the prior art contact lens fitted thereupon with the optical zone assuming a geometric line of sight for light entering the eye of the wearer, which is different than the true line of sight of sight for this specific eye.

FIG. 3B is a top view of a cross-section of an eye having a contact lens fitted thereupon with an optimal optical zone that is placed about the true line of sight for this specific eye.

### DETAILED DESCRIPTION OF THE INVENTION

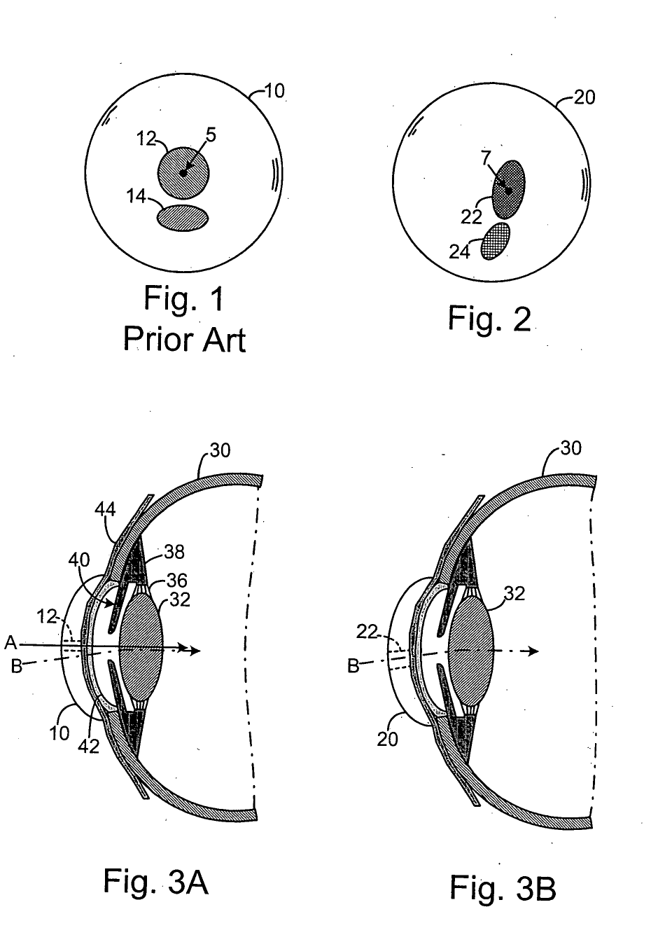

With reference to the figures in which like numerals represent like elements throughout, FIG. 2 illustrates one embodiment of the inventive contact lens 20 having a first optimized optical zone 22 and a second optimized optical zone 24 such that the contact lens 20 allows bifocal optical translation. The true line of sight 7 of the contact lens 20 has been determined to be away from the geometric line of sight, such as line of sight 5 of the prior art contact lens 10 in FIG. 1, and the optimized optical zones 22 and 24 accommodate the specific optical variations of the eye wearer and are placed within the contact lens in relation to the true line of sight of the wearer. The first optical zone 22 is intended to translate the light in the direct line of sight of the wearer, and the second optical zone 24 allows for a near-vision zone as is traditional in a bifocal contact lens. The line of sight 7 will accordingly travel optimally from the first optical zone 22 to the second optical zone 24 as the eye looks downward.

One problem that occurs in prior art contact lenses that assume a geometric alignment of the line of sight, such as contact lens 10 in FIG. 1, is shown in FIG. 3A. FIG. 3A is a top view of a cross-section of an eye 30 having the prior art contact lens 10 fitted thereupon with the optical zone 12 assuming a direct line of sight A for light entering the eye of the wearer. However, the true line of sight is line of sight B for this specific eye, which enters the eye at an angle off of the geometric center. In the visual system, the light enters the surface 44 of the eye 30, though the cornea 42, and then lens 32 and onto the retina. The lens 32 is actuated by the ciliary body 36 and conjunctiva 38 to naturally focus light in the eye 30, i.e. center of the contact lens 10. Due to the decentration of the fovea, (typically temporal and inferior), and the eye's aberrations, the line of sight of the eye is not typically aligned to the geometric or mechanical axis of the eye

When the inventive contact lens 20 is in situ on the eye 30, as shown in FIG. 3B, the optimal optical zone 22 is placed on the true line of sight 7 for this specific eye, shown as line of sight B. Optical zone 22 is centered about the true line of sight B for light entering the lens 32. Consequently, the wearer will have much better translated optics from the optical zone 22 of contact lens 20 for eye 30 corresponding to the true line of sight than the prior art contact lens 10 in FIG. 3A.

To maintain the contact lens 20 in the optimal position for the optical zone 22 to remain substantially in line with true line of sight B, the contact lens 20 can include mechanical features known in the art to keep the contact lens positionally maintained, such as ridges, ballast, and slab-offs. Further, the optimal placement of the one or more optical zones 22 and 24 can be determined from clinical analysis of the eye 30 of the wearer such as corneal topography and wavefront analysis. Such clinical measurement data is typically provided by the clinician to the manufacturer of the contact lens. And the placement of one or more optimal optical zones 22 and 24 of the contact lens 20 can be adjusted based upon use in the eye 30 of the wearer and iteration of the measurement and fitting process.

To manufacture the contact lens 20, any convenient manufacturing means, for example, such as lathing or molding, can be used. A person skilled in the art will know how to produce contact lenses of the invention from molding or direct lathing. Preferably, contact lenses are molded from contact lens molds including molding surfaces that replicate the contact lens surfaces when a lens is cast in the molds. For example, an optical cutting tool with a numerically controlled lathe may be used to form metallic optical tools. The tools are then used to make convex and concave surface molds that are then used, in conjunction with each other, to form the lens of the invention using a suitable liquid lens-forming material placed between the molds followed by compression and curing of the lens-forming material.

Several existing methods can be used that can adjust the optical zone(s) preferably, but not necessarily, in 3 dimensions. Methods such as an advanced lathe as shown in U.S. Pat. No. 6,122,999, or other multi-axis cutting system can be employed to appropriately shape the contact lens 20. Further, in a contact lens having complicated surface feature or optics, the optical tool to be used for making the same is fabricated by using a numerically controlled lathe, for example, such as Optoform® ultra-precision lathes (models 30, 40, 50 and 80) having Variform® or Varimax piezo-ceramic fast tool servo attachment from Precitech, Inc, according to a method described in a co-pending U.S. patent application of CibaVision, entitled Method for Manufacturing a contact lens, (U.S. Ser. No. 60/398,495, filed on Jul. 24, 2002), herein incorporated by this reference in its entirety.

As an illustrative example, production of a translating contact lens having a ramped ridge zone having a latitudinal ridge that is composed of two bumps can occur from the following setps. First, a user defines a set of parameters, such as a surface tolerance, a concentricity tolerance, orientation of the lens design, the number of spokes to be generated for each of the anterior and posterior surfaces, creating zero point at 0,0, orientation of Z-axis, and type of lens surface (concave or convex surface) to be converted into a geometry. A “surface tolerance” refers to the allowed position-deviation of a projected point from an ideal position on a surface of a lens design. The deviation can be in the direction either parallel or perpendicular to the central axis of a lens design. A “concentricity tolerance” refers to the allowed deviation of a point from a given arc. A “spoke” refers to a ray radiating outwardly from the central axis and is perpendicular to the central axis. A “semi-diameter spoke” refers to a line segment from the central axis to the edge of a lens design. “Evenly-spaced semi-diameter spokes” means that all semi-diameter spokes radiate outwardly from the central axis and separate from each other by one equal angle. A “point spacing” refers to a distance between two points along the semi-diameter spoke.

Second, a user determines the number of points to be projected onto the a surface of the lens design (for example, the anterior surface) along each of the number of evenly-spaced semi-diameter spokes in a direction parallel to the central axis. A semi-diameter spoke at an azimuthal angle, at which one of the two bumps of the anterior surface is located, is selected as the semi-diameter probing spoke. Evenly-spaced points are projected along the semi-diameter probing spoke, in which each pairs of points are separating by a point spacing of 10 microns. Then all of the projected points are divided into a series of groups, with each group composed of three consecutive points, a first point, a middle point, and a third point. Each of the points can belong to either one group or two groups. One group is analyzed at a time from the central axis to the edge, or from the edge to the central axis, from the curvature of the surface at the middle point of the group by comparing a distance between the middle point and a line linking the first point and the third point of the corresponding group with the predetermined surface tolerance. If the distance between the middle point and the line linking the first and third points of the group is larger than the predetermined surface tolerance, the curvature of the surface at that point is sharp and an additional point is projected between the first and the middle points in that group. The point spacing between the first and additional points is equal to point spacing between the additional and middle points. After adding an additional point, all of the points included the newly added point is regrouped again and the curvature of the surface at the middle point of each of the series of groups is analyzed. Such iterative procedure is repeated until the distance between the middle point of each of the series of groups and the line linking the first and the third points of corresponding group along the probing spoke is equal to or less than the predetermined surface tolerance. In this manner, the number of the points to be projected onto the surface of the lens design along each of the desired number of evenly-spaced semi-diameter spokes and point spacing for a series of pairs of neighboring points are determined.

The above-determined number of points is then projected onto the anterior surface of the lens design along each of 24, 96 or 384 semi-diameter spokes. For each of the semi-diameter spokes, a semi-meridian that is continuous in first derivative is generated. The semi-meridian includes a series of arcs and, optionally, straight lines wherein each arc is defined by fitting at least three consecutive points into a spherical mathematical function within a desired concentricity tolerance. Each of the straight lines is obtained by connecting at least three consecutive points. Preferably, the arc-fitting routine is started from the central axis to the edge. Similarly, conversion of the posterior surface of the lens design into a geometry can be carried out according to the above described procedure.

After converting the lens design to a geometry of a contact lens to be produced in a manufacturing system, a mini-file containing both the information for the header and the information about the geometry of the lens is generated. This mini-file also contains a zero semi-meridian that is based on the average height of each of the other meridians at each of radial locations and that gives the Variform a zero position on which it can base its oscillation calculations. In this mini-file, all semi-meridians have the same number of zones. This is accomplished by copying the last zone of a semi-meridian for a number of time to equalize the numbers of zones for all meridians. After the mini-file is complete, it is loaded into an Optoform(g ultra-precision lathe (models 30, 40, 50 or 80) having Variform® piezo-ceramic fast tool servo attachment and run to produce a translating contact lens.

The present invention therefore provides a method for manufacturing a contact lens 20 having one or more optimized optical zones 22 and 24 that can accommodate the specific optical variations of the eye 30 of the wearer including the steps of obtaining information about the true line of sight of the eye 30, wherein the true line of sight of the eye is determined by measuring the variation in the eye of a potential contact lens wearer, determining one or more optimal optical zones 22 and 24 for a contact lens 20 used in the eye 30 of the potential wearer such that the optical zone(s) is placed substantially on the true line of sight (such as true line of sight 7), and manufacturing the contact lens 20 to contain the one or more optimal optical zones 22 and 24. The step of manufacturing the contact lens 20 can occur with a multi-axis cutting system or through other manufacturing systems known in the art. Further, the step of obtaining the information about the true line of sight of the eye can be obtaining measurement data on the variation in the eye 30 of a potential contact lens wearer that was derived through the use of corneal topography, or through the use of wavefront analysis, or a combination of both methods.

The step of manufacturing the contact lens 20 can also include the step of manufacturing the lens with mechanical features such that the one or more optimal optical zones are positionally maintained in the eye 30 while worn by the wearer, such as with the inclusion of a ridge, ballast, and the like. Additionally, the steps of the method can be iterated to optimize the location of the one or more optical zones 22 and 24, and can utilize the input of the wearer to adjust the placement of the optical zone(s).

It is understood that the exact positioning of the optical zone may depend on where the lens sits on the eye. It is discovered that the center of a typical contact lens (e.g., spherical lens) is not precisely aligned to the mechanical center of the eye, but is located below the mechanical center of the eye, e.g., typically about 200 μm below the mechanical center of the eye. Such deviation of the center of a contact lens on an eye from the mechanical center of the eye (or the center of the cornea) can be determined, for example, by using a test lens. Preferably, the test lens has a visually marked center. More preferably, the test lens has a diameter and a curvature of the posterior surface (or base curve), which are almost identical to a contact lens to be designed and produced. Therefore, it is advantageous to determine deviation of the center of a contact lens on an eye from the mechanical center of the eye and then to use such data in the re-designing of the contact lens.

The position of the center of the lens and the center of the cornea can be measured with an eye tracking system. An example of such system is the ViewPoint EyeTracker system available from Arrington Research, Inc. In the preferred embodiment, the positional measurement will be made several minutes after the lens is on eye—after the lens has stabilized in primary gaze or in the preferred gaze.

While the foregoing disclosure shows illustrative embodiments of the invention, it should be noted that various changes and modifications could be made herein without departing from the scope of the invention as defined by the appended claims. Furthermore, although elements of the invention may be described or claimed in the singular, the plural is contemplated unless limitation to the singular is explicitly stated.

What is claimed is:

1. A contact lens having one or more optimized optical zones that accommodate the specific optical variations of the eye of the wearer, the one or more optical zones being placed within the contact lens in relation to the true line of sight of the wearer.

2. The contact lens of claim 1, wherein the contact lens includes mechanical features such that the one or more optical zones are positionally maintained in the eye while worn by the wearer.

3. The contact lens of claim 1, wherein the placement of the one or more optical zones is determined from measurement data derived from wavefront data and corneal topography of the eye of the contact lens wearer for primary gaze.

4. The contact lens of claim 1, wherein the placement of the one or more optical zones is determined from measurement data derived from the position of a test lens relative to the center of the cornea using an eye tracking system with the eye fixated in primary gaze.

5. The contact lens of claim 1, wherein the placement of one or more optical zones of the contact lens is adjusted based upon use in the eye of the wearer.

6. The contact lens of claim 1, wherein the one or more optical zones of the contact lens are created with a multi-axis cutting system.

7. A method for manufacturing a contact lens having one or more optimized optical zones that can accommodate the specific optical variations of the eye of the wearer, comprising the steps of:
obtaining information about the true line of sight of the eye, wherein the true line of sight of the eye is determined by measuring the variations in the eye of a potential contact lens wearer;
determining one or more optimal optical zones for a contact lens used in the eye of the potential wearer such that the optical zone is placed substantially on the true line of sight; and
manufacturing the contact lens to contain the one or more optimal optical zones.

8. The method of claim 7, wherein the step of manufacturing the contact lens occurs with a multi-axis cutting system.

9. The method of claim 7, wherein the step of manufacturing the contact lens includes the step of creating mechanical features on the contact lens such that the one or more optimal optical zones are positionally maintained in the eye while worn by the wearer.

10. The method of claim 7, wherein the step of obtaining information about the true line of sight of the eye is obtaining measurement data derived from wavefront data and corneal topography of the eye of the contact lens wearer for primary gaze.

11. The method of claim 7, wherein the step of obtaining information about the true line of sight of the eye is obtaining measurement data derived from the position of a test lens relative to the center of the cornea using an eye tracking system with the eye fixated in primary gaze.

12. The method of claim 7, wherein the steps of the method are iterated to optimize the location of the one or more optical zones.

13. A method for manufacturing a contact lens having one or more optimized optical zones that can accommodate the specific optical variations of the eye of the wearer, comprising the steps of:
a step for obtaining information about the true line of sight of the eye, wherein the true line of sight of the eye is determined by measuring the variation in the eye of a potential contact lens wearer to determine the line of sight of the eye;
a step for determining one or more optimal optical zones for a contact lens used in the eye of the potential wearer such that the optical zone is placed in relation to the true line of sight of the eye of the wearer; and
a step for manufacturing the contact lens to contain the one or more optimized optical zones.

14. The method of claim 13, further comprising a step for iterating the optimization of the one or more optical zones.
